(19) United States
(12) Patent Application Publication
(10) Pub. No.: US 2019/0054735 A1
(43) Pub. Date: Feb. 21, 2019

(54) TRANSFER PRINTING SYSTEM

(71) Applicant: Delphi Technologies, Inc., Troy, MI (US)

(72) Inventor: Jeffrey M. Detrick, Westfield, IN (US)

(21) Appl. No.: 15/677,375

(22) Filed: Aug. 15, 2017

(51) Int. Cl. B41J 2/005; B41J 2/21

(52) U.S. Cl. CPC B41J 2/0057; B41J 2002/012; B41J 2/21

(57) ABSTRACT

A transfer printing system includes an ink-jet printer, a transfer-surface, and a transfer-mechanism. The ink-jet printer dispenses jettable-material in a pattern. The transfer-surface accumulates the pattern which is subsequently transferred to a substrate. The substrate is characterized by a non-uniform surface. The transfer-mechanism moves the transfer-surface containing the pattern of jettable-material into contact with the substrate whereby the pattern of jettable-material is transferred from the transfer-surface to the substrate.

### TECHNICAL FIELD OF INVENTION

This disclosure generally relates to a method of transfer printing and more particularly relates to a method of transfer printing that applies a pattern to a non-uniform substrate.

### BACKGROUND OF INVENTION

It is known to indirectly print a pattern onto a substrate. The typical methods of transfer printing include screen-printing and/or stencil-printing the pattern onto a transfer-surface for subsequent transfer to the substrate. These methods typically require multiple printing steps when multi-color prints are required, that may include a curing operation between printing steps. Print registration issues occur when photo-quality registration is required, especially on non-uniform substrate surfaces, leading to poor image quality and long change-over times.

### SUMMARY OF THE INVENTION

In accordance with one embodiment, transfer printing system includes an ink-jet printer and a transfer-surface. The ink-jet printer that dispenses jettable-material in a pattern. The transfer-surface that accumulates the pattern which is subsequently transferred to a substrate.

In another embodiment, a method of transfer printing includes the steps of providing a transfer-surface, dispensing a pattern, providing a substrate, and transferring the pattern. The step of providing a transfer-surface includes providing a transfer-surface that accumulates a pattern of jettable-material. The step of dispensing the pattern includes dispensing, with an ink-jet printer, the pattern of jettable-material onto the transfer-surface. The step of providing the substrate includes providing the substrate. The step of transferring the pattern includes transferring, with a transfer-mechanism, the pattern of jettable-material from the transfer-surface to the substrate.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an illustration of a transfer printing system in accordance with one embodiment;

FIG. 2 is an illustration of a transfer printing system in accordance with one embodiment;

FIG. 3 is an illustration of a transfer printing system in accordance with one embodiment; and

FIG. 4 is a flow-chart of a method of operating the transfer printing systems of FIGS. 1-3 in accordance with another embodiment.

### DETAILED DESCRIPTION

Photo-quality printing is typically associated with methods of printing that use digital-reproduction printing techniques, such as ink-jet printing, laser-jet printing, etc. Described herein is a system and method of transfer printing that uses digital-reproduction techniques to obtain photo-quality registration of prints, especially on non-uniform surfaces where a droplet throw-distance to a substrate exceeds the limitation of the ink-jet printer. Additionally, print set-up times and tooling costs may be reduced, while the complexity of the print is increased.

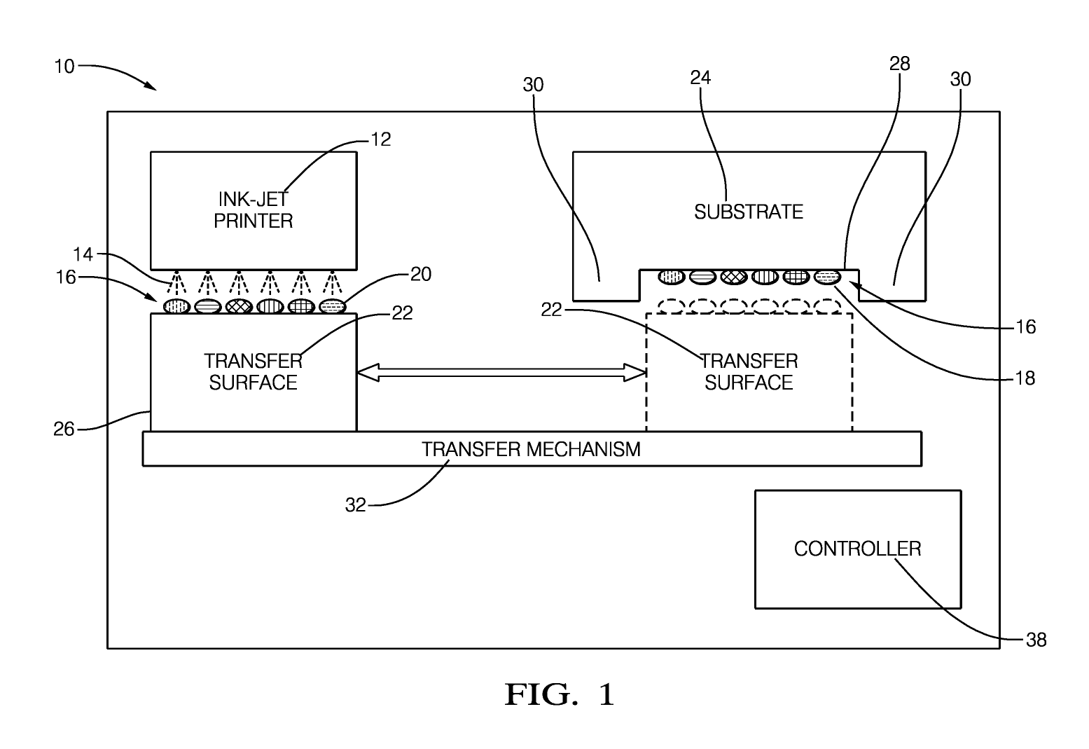

FIG. 1 illustrates a non-limiting example of a transfer printing system 10, hereafter referred to as the system 10. The system 10 includes an ink-jet printer 12 that dispenses jettable-material 14 in a pattern 16. As used herein, the term “ink-jet” includes any process of printing where a digital-image (i.e. a file stored in a computer memory) is printed onto a substrate 24. The ink-jet printer 12 may include any of the known, widely available commercial print-heads, and may vary depending on a type of jettable-material 14 being dispensed. The jettable-material 14 may include decorative-inks that may be used for labeling, conductive-material 18 that may be used for electric-circuits, acid-solutions that may be used for etching, dielectric-materials, photo-reactive materials, etc. The jettable-material 14 may be in a liquid-state and/or a solid-state (e.g. powders or materials used in 3D printing such as photoset polymers).

The pattern 16 may be any pattern 16 and may include lettering, numbering, logos, barcodes, images, electric-circuit traces, and may include a plurality of colors 20. The electric-circuit traces may include antennas, solder-pads, ground-planes, heat-sinks and other components known in the art that may transmit electrical-energy and/or electrical-signals.

The system 10 also includes a transfer-surface 22 that accumulates the pattern 16 which is subsequently transferred to a substrate 24. The transfer-surface 22 may include a flexible-pad 26, wherein the ink-jet printer 12 dispenses the pattern 16 of jettable-material 14 onto the flexible-pad 26. The flexible-pad 26 may be any shape required to interface with the substrate 24, and may be fabricated from a polymeric-material, such as a silicone-rubber. The flexible-pad 26 may have a durometer value (i.e. Shore hardness value) from about 20 Shore 00 to about 90 Shore 00.

The substrate 24 may be characterized by a non-uniform surface 28. That is, the substrate 24 may have a flatness variation greater than a range from about 1 mm to about 5 mm, and may include structural-obstacles 30 that may inhibit a movement of the print-head along the non-uniform surface 28. Examples include recessed-surfaces, curved-surfaces, angulated-surfaces, interior-surfaces, and combinations thereof.

The system 10 may also include a transfer-mechanism 32 that moves the flexible-pad 26 containing the pattern 16 of jettable-material 14 into contact with the substrate 24, and then retracts the flexible-pad 26 from the substrate 24, whereby the pattern 16 of jettable-material 14 is transferred from the flexible-pad 26 to the substrate 24. The transfer-mechanism 32 may temporarily retain the substrate 24 until the transfer of the pattern 16 is completed, and may include a means to load and unload the substrate 24. It will be understood by those in the art that the transfer-mechanism 32 may also move the substrate 24 into contact with the flexible-pad 26, depending on a design of the substrate 24.

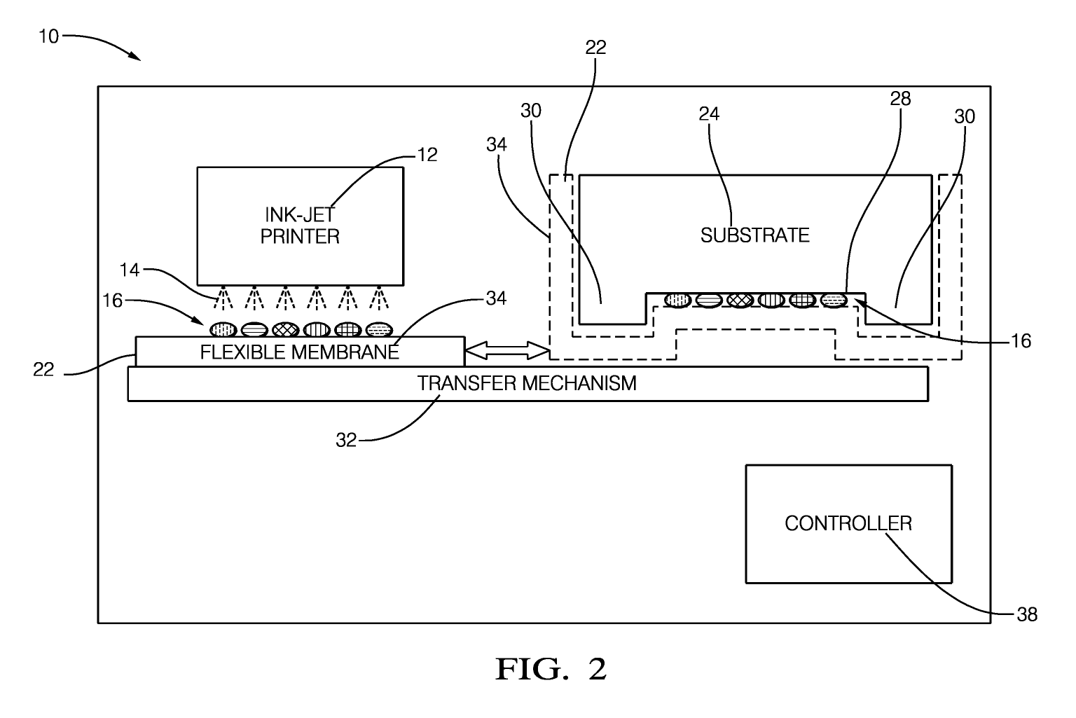

FIG. 2 illustrates another non-limiting example of the system 10 where the transfer-surface 22 may also include a flexible-membrane 34, and the ink-jet printer 12 dispenses the pattern 16 of jettable-material 14 onto the flexible-membrane 34. The system 10 may also include the transfer-mechanism 32 that wraps the flexible-membrane 34 containing the pattern 16 of jettable-material 14 about the substrate 24 and then unwraps the flexible-membrane 34 from the substrate 24, whereby the pattern 16 of jettable-material 14 is transferred from the flexible-membrane 34 to the substrate 24. The system 10 may employ a negative-pressure (i.e. a vacuum) to wrap the flexible-membrane 34 about the substrate 24, or may use a positive-pressure to force the flexible-membrane 34 about the substrate 24. The flexible-membrane 34 may be any of the known commercially available flexible-membranes 34, and may be fabricated from a polymeric material, such as silicone-rubber. Examples of the flexible-membrane 34 suitable for use as the transfer-surface 22 include the kSil™ membrane sheets manufactured by Silicone Engineering, Ltd. of La Quinta, Calif., USA.

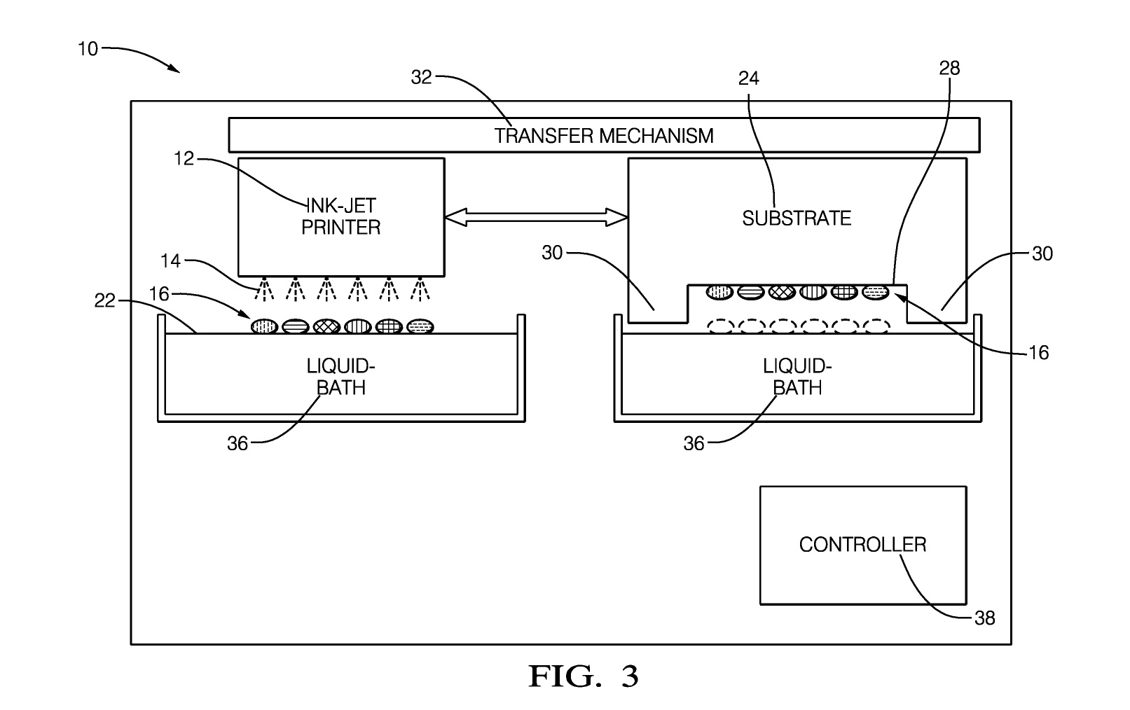

FIG. 3 illustrates yet another non-limiting example of the system 10 where the transfer-surface 22 may also include a liquid-bath 36, and the ink-jet printer 12 dispenses the pattern 16 of jettable-material 14 onto the liquid-bath 36. The system 10 may also include the transfer-mechanism 32 that dips the substrate 24 into the liquid-bath 36 containing the pattern 16 of jettable-material 14 and then removes the substrate 24 from the liquid-bath 36, whereby the pattern 16 of jettable-material 14 is transferred from the liquid-bath 36 to the substrate 24. The liquid-bath 36 may be any of the known commercially available liquid-baths 36 (a.k.a. hydrographic baths) suitable for transfer printing and may include baffles, filtration, and temperature control. The transfer-mechanism 32 may include a dipping-arm (not shown) configured to provide a consistent dipping-motion. It will be understood by those skilled in the art that the jettable-material 14 is compatible with liquids used in the liquid-bath 36.

The system 10 may also include a controller 38 in communication with the ink-jet printer 12, the transfer-surface 22, and the transfer-mechanism 32. The controller 38 may include a processor (not shown) such as a microprocessor or other control circuitry such as analog and/or digital control circuitry including an application specific integrated circuit (ASIC) for processing data as should be evident to those in the art. The controller 38 may include a memory (not shown), including non-volatile memory, such as electrically erasable programmable read-only memory (EEPROM) for storing one or more routines, thresholds, and captured data. The one or more routines may be executed by the processor to perform steps for transfer printing based on signals received by the controller 38 from the ink-jet printer 12, the transfer-surface 22, and the transfer-mechanism 32 as described herein.

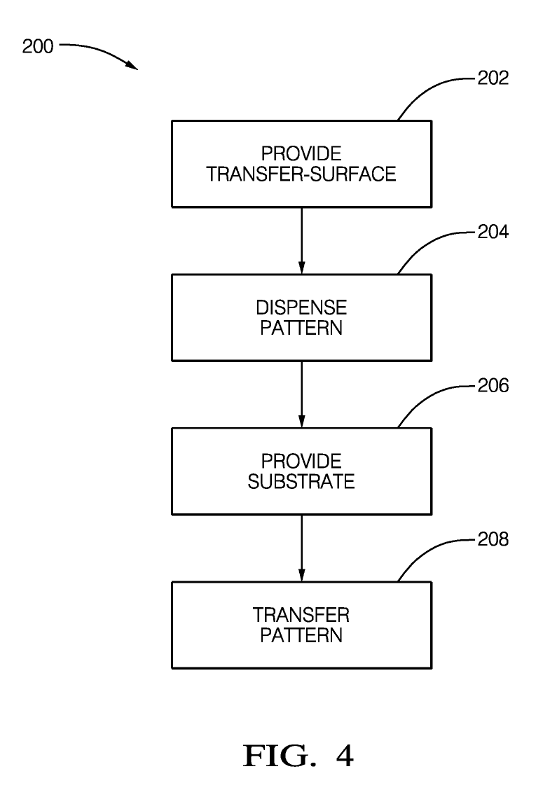

FIG. 4 illustrates a non-limiting example of a method 200 of operating a transfer printing system 10, hereafter referred to as the system 10.

Step 202, PROVIDE TRANSFER-SURFACE, may include providing a transfer-surface 22 that accumulates a pattern 16 of jettable-material 14. The transfer-surface 22 accumulates the pattern 16 which is subsequently transferred to a substrate 24. The transfer-surface 22 may include a flexible-pad 26, wherein an ink-jet printer 12 dispenses the pattern 16 of jettable-material 14 onto the flexible-pad 26. The flexible-pad 26 may be any shape required to interface with a substrate 24, and may be fabricated from a polymeric-material, such as a silicone-rubber. The flexible-pad 26 may have a durometer value (i.e. Shore hardness value) from about 20 Shore 00 to about 90 Shore 00.

Step 204, DISPENSE PATTERN, may include dispensing, with the ink-jet printer 12, the pattern 16 of jettable-material 14 onto the transfer-surface 22. The system 10 includes the ink-jet printer 12 that dispenses jettable-material 14 in the pattern 16. As used herein, the term “ink-jet” includes any process of printing where a digital-image (i.e. a file stored in a computer memory) is printed onto the substrate 24. The ink-jet printer 12 may include any of the known, widely available commercial print-heads, and may vary depending on a type of jettable-material 14 being dispensed. The jettable-material 14 may include decorative-inks that may be used for labeling, conductive-material 18 that may be used for electric-circuits, acid-solutions that may be used for etching, dielectric-materials, photo-reactive materials, etc. The jettable-material 14 may be in a liquid-state and/or a solid-state (e.g. powders or materials used in 3D printing such as photoset polymers).

The pattern 16 may be any pattern 16 and may include lettering, numbering, logos, barcodes, images, electric-circuit traces, and may include a plurality of colors 20. The electric-circuit traces may include antennas, solder-pads, ground-planes, heat-sinks, and other components known in the art that may transmit electrical-energy and/or electrical-signals.

Step 206, PROVIDE SUBSTRATE, may include providing the substrate 24. The substrate 24 may be characterized by a non-uniform surface 28. That is, the substrate 24 may have a flatness variation greater than a range from about 1 mm to about 5 mm, and may include structural-obstacles 30 that may inhibit a movement of the print-head along the non-uniform surface 28. Examples include recessed-surfaces, curved-surfaces, angulated-surfaces, interior-surfaces, and combinations thereof.

Step 208, TRANSFER PATTERN, may include transferring, with a transfer-mechanism 32, the pattern 16 of jettable-material 14 from the transfer-surface 22 to the substrate 24. The transfer-mechanism 32 moves the flexible-pad 26 containing the pattern 16 of jettable-material 14 into contact with the substrate 24, and then retracts the flexible-pad 26 from the substrate 24, whereby the pattern 16 of jettable-material 14 is transferred from the flexible-pad 26 to the substrate 24. The transfer-mechanism 32 may temporarily retain the substrate 24 until the transfer of the pattern 16 is completed, and may include a means to load and unload the substrate 24. It will be understood by those in the art that the transfer-mechanism 32 may also move the substrate 24 into contact with the flexible-pad 26, depending on a design of the substrate 24.

FIG. 2 illustrates another non-limiting example of the system 10 where the transfer-surface 22 may also include a flexible-membrane 34, and the ink-jet printer 12 dispenses the pattern 16 of jettable-material 14 onto the flexible-membrane 34. The transfer-mechanism 32 wraps the flexible-membrane 34 containing the pattern 16 of jettable-material 14 about the substrate 24 and then unwraps the flexible-membrane 34 from the substrate 24, whereby the pattern 16 of jettable-material 14 is transferred from the flexible-membrane 34 to the substrate 24. The system 10 may employ a negative-pressure (i.e. a vacuum) to wrap the flexible-membrane 34 about the substrate 24, or may use a positive-pressure to force the flexible-membrane 34 about the substrate 24. The flexible-membrane 34 may be any of the known commercially available flexible-membranes 34, and may be fabricated from a polymeric material, such as silicone-rubber. Examples of the flexible-membrane 34 suitable for use as the transfer-surface 22 include the kSil™ membrane sheets manufactured by Silicone Engineering, Ltd. of La Quinta, Calif., USA.

FIG. 3 illustrates yet another non-limiting example of the system 10 where the transfer-surface 22 may also include a liquid-bath 36, and the ink-jet printer 12 dispenses the pattern 16 of jettable-material 14 onto the liquid-bath 36. The transfer-mechanism 32 dips the substrate 24 into the liquid-bath 36 containing the pattern 16 of jettable-material 14 and then removes the substrate 24 from the liquid-bath 36, whereby the pattern 16 of jettable-material 14 is transferred from the liquid-bath 36 to the substrate 24. The liquid-bath 36 may be any of the known commercially available liquid-baths 36 (a.k.a. hydrographic baths) suitable for transfer printing and may include baffles, filtration, and temperature control. The transfer-mechanism 32 may include a dipping-arm (not shown) configured to provide a consistent dipping-motion. It will be understood by those skilled in the art that the jettable-material 14 is compatible with liquids used in the liquid-bath 36.

The system 10 may also include a controller 38 in communication with the ink-jet printer 12, the transfer-surface 22, and the transfer-mechanism 32. The controller 38 may include a processor (not shown) such as a microprocessor or other control circuitry such as analog and/or digital control circuitry including an application specific integrated circuit (ASIC) for processing data as should be evident to those in the art. The controller 38 may include a memory (not shown), including non-volatile memory, such as electrically erasable programmable read-only memory (EEPROM) for storing one or more routines, thresholds, and captured data. The one or more routines may be executed by the processor to perform steps for transfer printing based on signals received by the controller 38 from the ink-jet printer 12, the transfer-surface 22, and the transfer-mechanism 32 as described herein.

Accordingly, a transfer printing system 10, a controller 38 for the transfer printing system 10 and a method 200 of operating the transfer printing system 10 is provided. The system 10 is an improvement over other transfer printing systems, because the system 10 is capable of creating photo-quality registration of prints on non-uniform surfaces 28, especially where the droplet throw-distance to the substrate 24 exceeds the limitation of the ink-jet printer 12. In addition, the system 10 is beneficial because the system 10 reduces the time for changing images from part to part and change-over/setup-time between artworks.

While this invention has been described in terms of the preferred embodiments thereof, it is not intended to be so limited, but rather only to the extent set forth in the claims that follow.

1. A transfer printing system, said system comprising:
an ink-jet printer that dispenses jettable-material in a pattern; and
a transfer-surface that accumulates the pattern which is subsequently transferred to a substrate, wherein the jettable-material is a conductive-material, the conductive-material formulated for electric-circuits.

2. The system in accordance with claim 1, wherein the pattern of jettable-material includes a plurality of colors.

3. The system in accordance with claim 1, wherein the substrate is characterized by a non-uniform surface.

4. (canceled)

5. The system in accordance with claim 1, wherein the transfer-surface includes a flexible-pad, wherein the ink-jet printer dispenses the pattern of jettable-material onto the flexible-pad, and the system includes a transfer-mechanism that moves the flexible-pad containing the pattern of jettable-material into contact with the substrate and then retracts the flexible-pad from the substrate, whereby the pattern of jettable-material is transferred from the flexible-pad to the substrate.

6. The system in accordance with claim 1, wherein the transfer-surface includes a flexible-membrane, wherein the ink-jet printer dispenses the pattern of jettable-material onto the flexible-membrane, and the system includes a transfer-mechanism that wraps the flexible-membrane containing the pattern of jettable-material about the substrate and then unwraps the flexible-membrane from the substrate, whereby the pattern of jettable-material is transferred from the flexible-membrane to the substrate.

7. The system in accordance with claim 1, wherein the transfer-surface includes a liquid-bath, wherein the ink-jet printer dispenses the pattern of jettable-material onto the liquid-bath, and the system includes a transfer-mechanism that dips the substrate into the liquid-bath containing the pattern of jettable-material and then removes the substrate from the liquid-bath, whereby the pattern of jettable-material is transferred from the liquid-bath to the substrate.

8. A method of transfer printing, comprising:
providing a transfer-surface that accumulates a pattern of jettable-material;
dispensing, with an ink-jet printer, the pattern of jettable-material onto the transfer-surface;
providing a substrate; and
transferring, with a transfer-mechanism, the pattern of jettable-material from the transfer-surface to the substrate, wherein the jettable-material is a conductive-material, the conductive-material formulated for electric-circuits.

9. The method in accordance with claim 8, wherein the pattern of jettable-material includes a plurality of colors.

10. The method in accordance with claim 8, wherein the substrate is characterized by a non-uniform surface.

11. (canceled)

12. The method in accordance with claim 8, wherein the transfer-surface includes a flexible-pad, wherein the ink-jet printer dispenses the pattern of jettable-material onto the flexible-pad, and the step of transferring includes moving, with the transfer-mechanism, the flexible-pad containing the pattern of jettable-material into contact with the substrate and then retracting the flexible-pad from the substrate, whereby the pattern of jettable-material is transferred from the flexible-pad to the substrate.

13. The method in accordance with claim 8, wherein the transfer-surface includes a flexible-membrane, wherein the ink-jet printer dispenses the pattern of jettable-material onto the flexible-membrane, and the step of transferring includes wrapping, with the transfer-mechanism, the flexible-membrane containing the pattern of jettable-material about the substrate and then unwrapping the flexible-membrane from the substrate, whereby the pattern of jettable-material is transferred from the flexible-membrane to the substrate.

14. The method in accordance with claim 8, wherein the transfer-surface includes a liquid-bath, wherein the ink-jet printer dispenses the pattern of jettable-material onto the liquid-bath, and the step of transferring includes dipping, with the transfer-mechanism, the substrate into the liquid-bath containing the pattern of jettable-material and then removing the substrate from the liquid-bath, whereby the pattern of jettable-material is transferred from the liquid-bath to the substrate.
